(19) United States
(12) Patent Application Publication
(10) Pub. No.: US 2026/0307498 A1
(43) Pub. Date: Oct. 8, 2026

(54) DRIVING RANGE ESTIMATION

(71) Applicant: JAGUAR LAND ROVER LIMITED, Whitley, Coventry, Warwickshire (GB)

(72) Inventors: Laurentiu-Antonin CANCEL, Whitley, Coventry, Warwickshire (GB); Thomas MOURRÉ, Whitley, Coventry, Warwickshire (GB)

(21) Appl. No.: 19/480,681

(22) PCT Filed: Apr. 30, 2024
(86) PCT No.: PCT/EP2024/061913

§ 371 Date: Oct. 31, 2025

(30) Foreign Application Priority Data
May 2, 2023 (GB) 2306444.7

(51) Int. Cl. B60L 3/12

(52) U.S. Cl. CPC B60L 3/12; B60L 2240/12; B60L 2240/642; B60L 2250/16

(57) ABSTRACT

A control system is configured to receive route information concerning a journey planned to be undertaken by the vehicle, determine, from the route information, a driving profile for the journey, the driving profile including an expected vehicle speed for each of a plurality of segments of the journey, and determine an adjusted vehicle speed for each segment in dependence on an adjustment factor, the adjustment factor based on historical driving data for the vehicle. The control system is further configured to estimates the driving range for the vehicle based on the adjusted vehicle speeds for each segment of the journey, and outputs a signal indicative of the estimated driving range. In this way, the driving range estimate is able to take into account the manner in which the vehicle has previously been driven, by applying an adjustment factor to more generic vehicle speed information, the adjustment factor being based on historical driving data.

### TECHNICAL FIELD

The present disclosure relates to a system and method for driving range estimation. Aspects of the invention relate to a system, a method of estimating driving range, a computer program and a vehicle.

### BACKGROUND

Battery Electric Vehicles (BEVs) are powered entirely by electrical power stored in batteries.

This electrical power is finite, and the vehicle is capable of travelling only a certain distance before the battery is empty. The maximum range of the vehicle on a single battery charge is highly variable, and is a function of a number of factors including ambient temperature, vehicle speed, how the vehicle is being driven and the vehicle systems being powered in addition to propulsion. As a result, there are multiple parameters influencing the range prediction, which could lead to inaccuracy in the prediction. Two of the main factors influencing range are the driving profile of the road ahead, and speed limitations that will be present on the journey and how the driver would react to them (driving style).

Inaccuracies in the range prediction resulting from the driving profile can be resolved by using information about the journey ahead coming from the navigation system, including the distance to destination, the road gradient, average speed on sections of the road ahead, and speed limits. However, this approach has some limitations because the average speed on the road is based on an aggregated dataset from multiple users (that is, how other drivers have driven on those segments), which may not reflect the probable average speed of the instant driver.

This average speed error directly impacts the magnitude of the aerodynamic drag force applied on the vehicle which then introduces a bias into the battery range prediction.

It is an aim of the present invention to address one or more of the disadvantages associated with the prior art.

### SUMMARY OF THE INVENTION

Aspects and embodiments of the invention provide a control system, a method of controlling vehicle steering, a computer program and a vehicle, as claimed in the appended claims.

In one aspect, there is provided a control system for estimating a driving range for an electric vehicle, the control system comprising one or more controller, the control system configured to:
receive route information concerning a journey planned to be undertaken by the vehicle;
determine, from the route information, a driving profile for the journey, the driving profile comprising an expected vehicle speed for each of a plurality of segments of the journey;
determine an adjusted vehicle speed for each segment in dependence on an adjustment factor, the adjustment factor being based on historical driving data for the vehicle;
estimate the driving range for the vehicle based on the adjusted vehicle speeds for each segment of the journey; and
output a signal indicative of the estimated driving range.

In this way, the driving range estimate is able to take into account the manner in which the vehicle has previously been driven, by applying an adjustment factor to more generic vehicle speed information, the adjustment factor being based on historical driving data (for the vehicle).

Reference to ‘the control system being configured to’ is to be understood to mean ‘the one or more controllers of the control system are collectively configured to’.

The present technique is particularly beneficial for a battery electric vehicle in which propulsion is provided solely by one or more electric motors (that is, a vehicle which does not have an internal combustion engine). For a battery electric vehicle (BEV) the range estimation is very important, since it represents the full driving range of the vehicle. However, the present technique may also be beneficially applied to a hybrid electric vehicle (such as a Plug-In Hybrid Electric Vehicle (PHEV)) having both an internal combustion engine and one or more electric motors (for providing vehicle propulsion) powered by batteries, and having at least one driving mode in which propulsion is delivered entirely by the electric motors. In this case a vehicle driving range in the electric propulsion driving mode may be estimated more accurately than conventional methods by using the present technique.

The control system may be configured to:
monitor a driven speed of the vehicle for a journey segment;
compare the driven speed of the vehicle with an expected vehicle speed for that journey segment; and
determine the adjustment factor based on a difference between the driven speed and the expected speed.

These steps of monitoring, comparing and determining may be based on the current journey (that is, the journey in relation to which the range is being estimated), or a previous journey. It will be appreciated that this process may be ongoing, with each journey providing new data as to how the vehicle is driven, thereby improving the accuracy of the historical driving data, and improving the accuracy of the resulting adjustment factor. In other words, the historical data may be built up over time, including based on the current journey. In the latter case the resulting adjustment factors may be used immediately in updating the range estimate. It will further be appreciated that the adjustment factor and/or the historical data will typically be stored in a memory, and updated in the memory over time as the monitoring progresses.

In any case, in this way, historical driving data may be obtained, and accumulated over time. The historical driving data may in this case be a speed offset (e.g. +/−X kph) from an expected vehicle speed (the expected vehicle speed being based either on an aggregated data set for multiple drivers, or a speed based on other considerations such as a speed limit, road type or gradient for example). Where the expected vehicle speed is based on an aggregated data set for multiple drivers, this may be derived from a separate source of driving data from that accumulated using the present technique and/or from other drivers operating a vehicle carrying out the present technique. In other words, the historical driving data used with the present technique to determine and refine the adjustment factors may further be used as, or to generate, expected vehicle speed information in an aggregated data set used by other drivers (and in practice the instant driver too). Where the aggregated data set is derived from a separate source of driving data, this may simply be any form of measurement of actual vehicle speeds as vehicle traverse a particular road segment. A baseline expected vehicle speed for a particular road segment may for example simply be the actual average speed of all vehicles measured traversing that segment.

The control system may be configured to compare the driven speed of the vehicle with an expected vehicle speed for each of a plurality of speed ranges, and to determine an adjustment factor for each speed range. The speed range is preferably a range of expected vehicle speed, but in some implementations may be a range of driven speed. In this way, speed ranges may be provided with adjustment factors as and when sufficient historical driving data is acquired to determine them. The system may acquire adjustment factors for some speed ranges before others. Until sufficient data is obtained to enable an adjustment factor to be accurately determined in relation to a particular speed range, the expected vehicle speed may be used for that speed range instead, or an assumed adjustment factor may be generated based on historical driving data for other speed ranges (for example neighbouring speed ranges), or an assumed adjustment factor may be generated in another way.

The control system may be configured to monitor the driven speed of the vehicle, compare the driven speed of the vehicle with an expected vehicle speed, and determine the adjustment factor based on the difference, during the planned journey, and to use the newly determined adjustment factor to refine the driving range estimate. In this way, the range estimate may be refined as a journey progresses, taking into account the driver's most recent driving behaviour (during the current journey itself).

The control system may be configured to estimate the driving range by predicting an energy consumption for each of the plurality of journey segments, each journey segment representing a constant expected vehicle speed and road gradient. Once the energy consumption has been calculated for the whole journey, utilising the adjusted speed values for segments where available (where the adjusted speed values are not available for a particular speed range for example, the expected vehicle speed may be used instead), this can be compared with the state of charge (available energy) of the battery to determine whether the vehicle has sufficient battery range to complete the journey. If not, the point at which the vehicle battery would be depleted to zero can be identified (and used to plan a recharging stop). If the battery state is adequate to complete the journey, the battery range left at the completion of the journey may also be identified.

The control system may be configured to estimate the driving range by aggregating segments by vehicle speed and additionally by road gradient, and determining an energy consumption for each aggregated group of segments. In this way, it is possible to make the computation more accurate in cases where different drivers may react (drive) differently on different road gradients. For example, a particular driver may be quite sensitive to differing road gradients, for example driving relatively carefully (and thus more slowly) on higher gradients (uphill or downhill) compared with on flat roads. Another driver may not differ in driving style significantly as a function of road gradient.

The control system may be configured to estimate the driving range substantially immediately upon selection of the planned journey. This is beneficial because the driver may be able to enter the vehicle, ready themselves to drive, and be provided with the estimated vehicle range before they launch the vehicle.

In some simple implementations a single adjustment factor may be applied, based on the historical driving data for the vehicle, irrespective of vehicle speed. This might for example be a percentage uplift or reduction from the expected vehicle speed by +/−X %. However, more advanced implementations take into account that a particular driver may vary from an average driver by a greater or lesser extent at different (expected) vehicle speeds. For example, a particular driver may drive at similar speeds to an average driver at low speeds around built up areas, but may drive significantly more aggressively than average at higher speeds on motorways. To account for this, the control system may be configured to select an adjustment factor for determining the adjusted vehicle speed in dependence on the expected vehicle speed for a segment of the journey.

In some implementations, if an amount of data collected and generated by the monitoring and comparing steps is less than a threshold amount for a given expected vehicle speed or speed range, the control system may be configured to estimate the driving range using the expected vehicle speed rather than an adjusted vehicle speed for that expected vehicle speed or speed range.

The control system may be configured to determine a driving style based on the historical driving data, and to set the adjustment factor based on the determined driving style. In a simple case, this could be (as referenced above) simply applying a single adjustment factor independently of vehicle speed. Alternatively though, the adjustment factor applied for a given driving style may vary as a function of (expected vehicle speed).

The control system may be configured to use an adjustment factor determined based on driven speeds for a speed range corresponding to the current segment if available, and to use an adjustment factor based on determined driving style otherwise. In this case, driving style is used as a mechanism to provide a coarse estimate of what the adjustment factor could be expected to be before speed-relevant data becomes available.

It will be appreciated that, in some cases, more than one individual may have use of (drive) the vehicle. Each individual may drive differently. To cater for this, the control system may be configured to receive a signal indicative of the identity of a driver of the vehicle, and to select the adjustment factor in dependence on the identified driver. Various ways of achieving this are known-such as facial recognition using a camera in the vehicle cabin, the presence of a particular portable electronic device (for example a smartphone) or fob, or entry or selection of a driver via an infotainment system of the vehicle. In this case, the control system may be configured to determine the adjustment factor in relation to the identified driver based on historical driving data associated with the identified driver.

Preferably, the control system is configured to display the driving range estimate indicated by the outputted signal on a user interface of the vehicle.

According to another aspect there is provided a vehicle comprising a control system as described above.

According to another aspect there is provided a method for estimating a driving range for an electric vehicle, the method comprising:
receiving route information concerning a journey planned to be undertaken by the vehicle;
determining, from the route information, a driving profile for the journey, the driving profile comprising an expected vehicle speed for each of a plurality of segments of the journey;
determining an adjusted vehicle speed for each segment in dependence on an adjustment factor, the adjustment factor being based on historical driving data for the vehicle; and
estimating the driving range for the vehicle based on the adjusted vehicle speeds for each segment of the journey; and
outputting a signal indicative of the estimated driving range.

In another aspect, there is provided computer readable instructions which, when executed by a computer, are arranged to perform a method according to the above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a schematic representation of a vehicle having a battery, an electric propulsion system, a control system, and a display;

FIGS. 2A and 2B schematically illustrate a control system and a group of vehicle controllers;

FIG. 3 schematically illustrates control system components for estimating a vehicle range;

FIG. 4 schematically illustrates a set of differing speed profiles dependent on driving style;

FIG. 5 schematically illustrates one embodiment of a predictive energy optimisation system;

FIG. 6 schematically illustrates another embodiment of a predictive energy optimisation system; and

FIG. 7 shows a schematic flow diagram of the control method.

### DETAILED DESCRIPTION

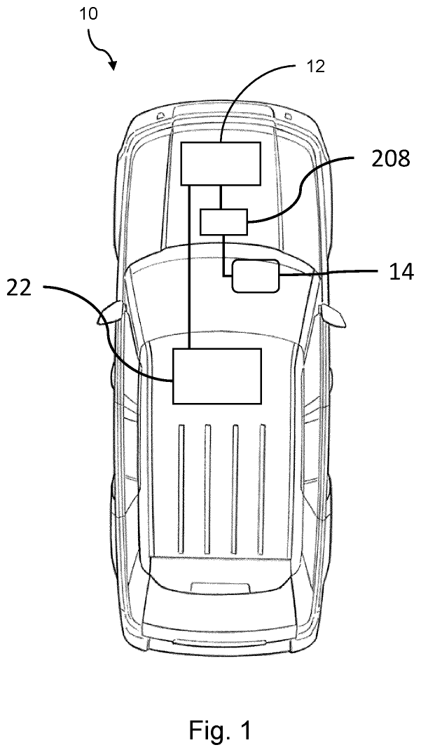

FIG. 1 illustrates an example of a vehicle 10 in which embodiments of the invention can be implemented. In some, but not necessarily all examples, the vehicle is a passenger vehicle, also referred to as a passenger car or as an automobile. In other examples, embodiments of the invention can be implemented for other applications, such as commercial vehicles.

The vehicle 10 is a battery electric vehicle (BEV). The range estimation provided by the present technique therefore identifies an estimate for the total range of the vehicle based on its current battery fill (charge) level. However, the present range estimation technique could also be applied to a hybrid electric vehicle, for example a plug-in hybrid electric vehicle (PHEV) having an electric-only mode of operation, in which case the present technique may be used to estimate a range which the vehicle is able to travel in the electric-only mode. The vehicle 10 comprises a plurality of systems including a propulsion system 12, control system 208, and energy storage means 22 for powering the propulsion system 12, such as one or more batteries, for example one or more high voltage batteries. The vehicle 10 also comprises a display 14, for example disposed on an instrument panel in the vehicle cabin, which displays an estimate of the vehicle range.

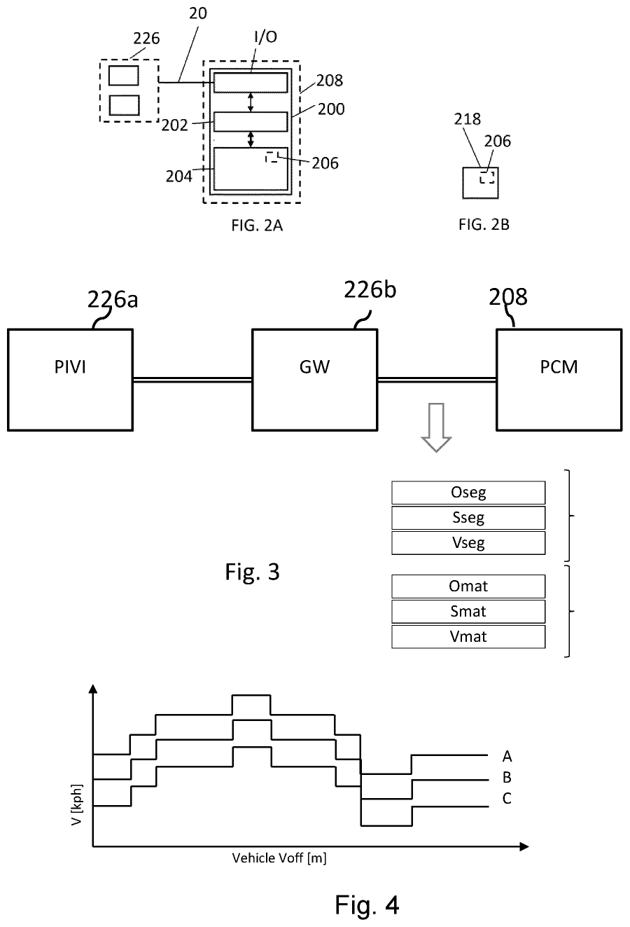

The control system 208 is configured to implement any one or more of the methods described herein. FIG. 2A illustrates how the control system 208 may be implemented. The control system 208 of FIG. 2A illustrates a controller 200. In other examples, the control system 208 may comprise a plurality of controllers 200 onboard and/or off board the vehicle 10. In examples any suitable control system 208 can be used.

The controller 200 of FIG. 2A includes at least one processor 202; and at least one memory device 204 electrically coupled to the electronic processor 202 and having instructions 206 (for example a computer program) stored therein, the at least one memory device 204 and the instructions 206 configured to, with the at least one processor 202, cause any one or more of the methods described herein to be performed.

FIG. 2A therefore illustrates a control system 208, wherein the one or more electronic controllers 200 collectively comprise: at least one electronic processor 202 having an electrical input for receiving information associated with energy storage control; and at least one electronic memory device 204 electrically coupled to the at least one electronic processor 202 and having instructions 206 stored therein; and wherein the at least one electronic processor 202 is configured to access the at least one memory device 204 and execute the instructions thereon so as to cause the control system 208 to perform and/or cause performance of any one or more of the methods described herein.

Also illustrated in the example of FIG. 2A are one or more vehicle systems 226. In examples, the vehicle system(s) 226 can comprise any suitable vehicle system(s). For example, the vehicle system(s) 226 can comprise any suitable vehicle system(s) 226 from which the control system 208 can receive and/or to which the control system 208 can transmit, directly or indirectly, one or more signals 20, for example to control an energy storage means 22 of a vehicle 10. In examples, the one or more vehicle systems 226 comprise one or more systems involved in control of an energy storage means of the vehicle 10. In examples, the one or more vehicle systems 226 comprise one or more systems involved in control of state of charge of an energy storage means 22 of the vehicle 10. For example, one or more vehicle systems 226 can comprise any suitable system or systems 226 of the vehicle configured to provide energy to and/or draw energy from energy storage means 22 of the vehicle 10. For example, the one or more vehicle systems 226 can comprise one or more energy recovery systems and/or one or more electric motors and so on. In examples, the one or more vehicle systems 226 can comprise one or more systems configured to report on the present state and/or present usage of energy by the energy storage means 22 of the vehicle 10. In examples, the one or more vehicle systems 226 can comprise one or more systems configured to provide information to allow a determination of a predicted destination 12 for the vehicle 10 and/or an associated confidence value. In examples, the one or more systems 226 comprise a powertrain controller module and/or an infotainment system.

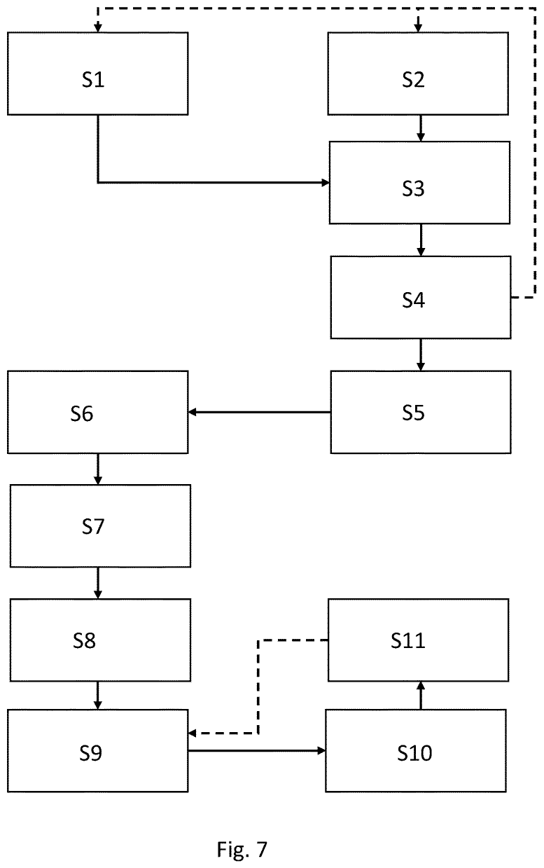

FIG. 2B illustrates a non-transitory computer readable storage medium 218 comprising the instructions 206 (computer software). Accordingly, FIG. 2B illustrates a non-transitory computer readable medium 218 comprising computer readable instructions 206 that, when executed by a processor 202, cause performance of at least the method of one or more of FIG. 7 and/or as described herein.

In FIG. 3, several of the vehicle systems 226 are shown, including a Plug-In-Vehicle Infotainment system (PIVI) 226a, a gateway (GW) module 226b and a powertrain control module, which in the present implementation corresponds to the control system 208. The PIVI 226a carries out navigation functionality, and outputs eHorizon data to the gateway module 226b over an ethernet connection. The eHorizon data comprises route information concerning a journey planned to be undertaken by the vehicle. The gateway module 226b provides requested information to the powertrain control module (control system 208). The requested information includes, for each of the segments of the planned journey, a segment offset (O_{seg}), a segment gradient (S_{seg}), and a segment speed (V_{seg}). The segment offset is in effect a length/distance of the segment (since subtracting the offset of a preceding segment from a particular segment will provide the length of the particular segment), the segment gradient is a road gradient for the segment. This may be an average gradient for the portion of the road corresponding to that segment. Since segments need not be all of the same length, generally new segments will be defined whenever the road gradient changes significantly, with the result that the gradient is at least generally uniform for the portion of road corresponding to any given segment. The segment speed is an assumed average speed for the segment, based on historical traffic data from multiple users. It will be appreciated that different users may traverse the segment at different speeds, and the segment speed is an average of these, collected by any suitable method.

The requested information may be considered to be a driving profile for the journey. The driving profile therefore comprises an expected vehicle speed for each of a plurality of segments of the journey (each segment having a particular gradient, and a length). Using the driving profile, and in particular these three parameters, along with a set of constants C1, C2, C3, it is possible to estimate an amount of energy which will be consumed during traversal of each segment, according to the following Equation (1):

$${E}_{segment} [ J ] = ( {C}_{1} + {C}_{2} \cdot {V}_{segment} + {C}_{3} \cdot {V}_{segment}^{2} + m \cdot g \cdot \frac{{S}_{segment} [ \% ]}{100} ) \cdot {L}_{segment} [ m ]$$

In equation (1), E_{segment} [J] is the amount of energy (in Joules) consumed by traversal of the segment (output), V_{segment} is the segment speed, m is the mass of the vehicle (kg), g is the gravitational constant, S_{segment} is the gradient of the segment, and L_{segment} is the length of the segment (in metres).

The energy consumption for the entirety of the planned journey can be estimated by aggregating the estimates for the individual segments. The energy consumption for the journey can be used to estimate the range of the vehicle along (or including) the route of the planned journey. The estimated range is displayed to the driver, which informs the driver of whether the vehicle has sufficient range to complete the planned journey. In this way, the driver is aware of (a) whether the vehicle can complete the planned journey without recharging the battery, (b) if so, the remaining range of the vehicle once the journey is completed, and (c) if the journey cannot be completed without recharging, how far along the planned journey the vehicle can travel before recharging is required. For example, if the energy consumption for the planned journey is estimated to be approximately 70% of the energy stored in the vehicle battery, the estimated range would be the distance of the planned journey, plus a range of the vehicle at default energy consumption starting from 30% battery charge.

Carrying out this estimate of energy consumption on a per-segment basis may be computationally expensive. It is desirable that the range estimate be provided to the driver very quickly, preferably substantially immediately upon selection of the planned journey, and preferably before the journey commences (so that the driver is made aware of whether the journey can be completed without recharging before departing). It is therefore preferable if this computation can be handled as quickly as possible.

One way to achieve this is to aggregate like-segments together (that is, segments having the same gradient and the same segment speed). The length of these like-segments can then be added together, to define a group of segments having a combined length. Equation (1) above can then be carried out on each group of segments, and the estimates for each group aggregated to give the estimate for the entire journey.

In this case, the segment information may be provided in matrix form, and comprises a matrix offset (Oₘₐₜ) (combined length of all segments in a group), matrix gradient (Sₘₐₜ) (common gradient for group), and matrix speed (Vₘₐₜ) (common speed for group). Then, the matrix offset, matrix gradient and matrix speed may be substituted for the segment offset, segment gradient and segment speed in equation (1) above, and the Energy consumption aggregated for each group of segments.

Generally, acceleration/deceleration events are not taken into account for energy calculation, and it may be expected that the impact of this is limited due to the acceleration and deceleration events cancelling each other out (for example due to regenerative braking).

Conventionally, it is assumed that the driver of the vehicle is following the average speed profile from the eHorizon data. However, this assumption may often not be correct, leading to inaccuracies in the range estimate. In particular, the average speed profile, defining the expected speeds, is based on an aggregated data set for multiple drivers. The actual driver may handle the vehicle differently from the average of the data set, deviating from the expected speeds, resulting in a range estimate which is either too high or too low.

The present technique improves on this by determining an adjusted vehicle speed (preferably for each segment) in dependence on an adjustment factor, where the adjustment factor is based on historical driving data for the vehicle (or in some cases for the driver, or the driver and vehicle in combination).

As a result, the driving range may be estimated for the vehicle based on the adjusted vehicle speeds for each segment of the journey, which can be expected to give rise to a more accurately estimated driving range.

The historical driving data may be obtained by monitoring a driven speed of the vehicle for a journey/road segment, and comparing the driven speed of the vehicle with an expected vehicle speed for that journey/road segment (that is, the segment speed referred to above). This may have been carried out over one or more prior journeys (although data from the present journey may also be used). In a simple case, the adjustment factor may be determined based on a difference between the driven speed and the expected speed. Generally though, the monitoring and comparing will take place in relation to multiple segments (having the same or similar gradient, and/or the same or similar speed), with the differences in speed being averaged over those multiple segments to obtain a more robust history of how the vehicle is being driven by the current driver.

An adjustment factor may be determined for each of a plurality of speed ranges (of the segment speed). More specifically, each segment has a segment speed, as described above, which is an average speed for multiple users. When a segment speed is being compared with an actual driven speed for the segment, an adjustment factor relating the actual driven speed to the segment speed is determined and associated with a speed range which contains the segment speed. Over multiple driven segments, the comparison of the driven speed of the vehicle with an expected vehicle speed is thus carried out (preferably multiple times) for each of a plurality of speed ranges. Ultimately, this will result in adjustment factors being determined for each speed range between zero and the maximum speed of the vehicle.

In some cases the segments may be grouped by gradient as well as speed, which might be beneficial if the driver's driving style should differ from “average” by a differing amount dependent on gradient. However, this is optional. If this feature is implemented, the resulting data set would give rise to adjustment factors as a function of segment speed and segment gradient. In use, the vehicle controllers would therefore identify, for each segment on the planned journey, the segment gradient and the segment speed, and look up the resulting adjustment factor (for example from a lookup table). The energy consumption calculation would then take place using the segment length, the segment gradient and the adjusted speed value.

Prior to the commencement of the journey, the historical driving data is based on previous journeys undertaken by the vehicle (and not necessarily of the same route—the adjustment factors can be determined based on any prior journeys). If no previous journeys have been carried out (or insufficient journeys to build up reliable speed data), there will be no historical driving data to use in generating adjustment factors. In this case the unadjusted data (raw segment speed) is used instead. At this stage, a vehicle range estimate may be determined and displayed (as described above) based only on the planned journey, and historical driving data obtained from prior journeys (if available).

During the planned journey itself, the system monitors the driven speed of the vehicle, and compares this with an expected vehicle speed (for the segment being traversed). The adjustment factor is then determined (or refined) based on the difference, during the planned journey. The newly determined adjustment factor is then used to refine the driving range estimate. If no historical driving data existed prior to commencement of the journey, then the adjustment factor may be based entirely on the driven speed of the vehicle (and its comparison with expected vehicle speeds) during the course of the current journey. This will mean that at the outset of the journey the range estimate uses generic driving data which is unadjusted, but that as new driving data is generated from the current journey (for the various speed ranges), adjustment factors will be applied for those speed ranges for which adequate driving data has been accumulated. This may mean that at least a predetermined number of segments of a particular speed range (of expected vehicle speed) are traversed by the vehicle/driver before an adjustment factor is used for that range. In some embodiments an adjustment factor may not be used until it is determined to be sufficiently robust or reliable. For example, an adjustment factor may not be used until the differences between the driven speed and the expected speed within a given speed range have stabilised at a value, or are based on sufficient driven speed data, or have a variance less than a predetermined amount. The skilled person will be aware of other techniques for determining the stability or reliability of data.

Optionally, the historical driving data used to determine the adjustment factors may be the most recent driving data, or the adjustment factors may be determined based on a weighted average of historical driving data in which more recent driving data is awarded extra weight. This may be particularly important when the vehicle is new, since a driver may drive more cautiously until they become used to the handling of the vehicle.

In one simple implementation, a driving style for the driver is determined based on the historical driving data, and a speed adjustment factor (or factors) is selected based on the determined driving style. This driving style might for example be “aggressive”, “default” or “economical”. For example, a driven speed of the vehicle may be monitored, and compared with an expected vehicle speed, and the driving style determined based on the magnitude and direction of the difference. The differences may be aggregated over time, and may either be absolute values, or proportional (for example percentage over or under the expected vehicle speed). If the driven speed is determined, on average, to be less than the expected speed by a first threshold amount, the driving style may be classified as “economical”. If the driven speed is determined, on average, to be greater than the expected speed by a second threshold amount, the driving style may be classified as “aggressive”. Otherwise, the driving style may be classified as “default”. The adjustment factor is then set based on the determined driving style. For example, if the driving style has been classified as “economical”, a first adjustment factor may be applied, which is less than 1, and which results in an adjusted vehicle speed which is less than the expected vehicle speed. If the driving style has been classified as “aggressive”, a second adjustment factor may be applied, which is greater than 1, and which results in an adjusted vehicle speed which is greater than the expected vehicle speed. If the driving style has been classified as “default”, an adjustment factor of 1 may be applied, resulting in no adjustment to the expected vehicle speed. The first and second thresholds may have the same magnitude, or may have different magnitudes. In one example a single uniform adjustment factor is applied for all segment speeds. In another example different adjustment factors are applied to different ranges of segment speed, but still dependent on the determined driving style.

FIG. 4 shows how the different driving styles may be represented on a graph of speed profile (in kph) versus vehicle offset (distance into journey). The top line “A” shows the “aggressive” driving style, which can be seen to be at a fixed (and positive) speed offset with respect to a default driving style “B” (which corresponds to the “average” vehicle speed provided in the eHorizon data) which is shown in the middle line of FIG. 4. The bottom line “C” shows the “economical” driving style, which can be seen to be at a fixed (and negative) speed offset with respect to the default driving style. In alternative embodiments the offset may be variable (that is, not the same magnitude for a given speed range).

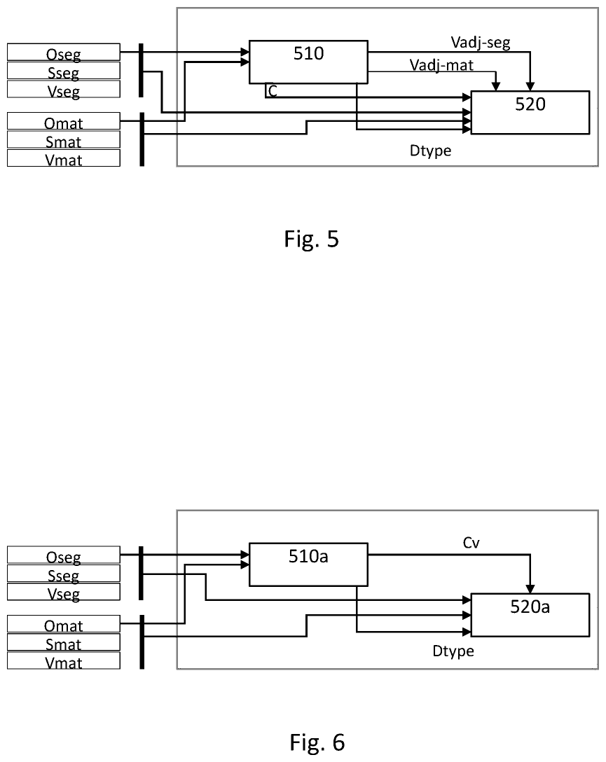

Referring to FIG. 5, a functional representation of a predictive energy optimisation control system is shown. The segment offset O_{seg}, segment gradient S_{seg} and segment speed V_{seg} are provided both to a driver characterisation function 510 and also to an energy calculation function 520. The driver characterisation function 510 also receives a driven speed V_{driv} of the vehicle for a road segment currently being traversed by the vehicle. The driver characterisation function 510 also receives (or otherwise has access to) a set of speed adjustment factors which are based on historical driving data (that is, based on comparisons between driven (actual) speeds and expected speeds for the driver). The driver characterisation function 510 adjusts the segment speed V_{seg} using the relevant speed adjustment factor, and outputs the corrected (adjusted) segment speed V_{adj-seg} to the energy calculation function 520. It also (or alternatively) outputs an indication C of whether a corrected segment speed is available. The energy calculation function 520 then calculates the energy consumption for the journey, and resulting range estimate, based on the corrected segment speeds, as described above (if the corrected segment speed is available). If the corrected segment speed is not available (which may be because there is either no data, insufficient data (less than a threshold amount of data), or unreliable data relating to how the vehicle is being driven at the relevant speed), then the unadjusted value of segment speed may be used instead. The driver characterisation function 510 also outputs an indication of the driving style D_{style} of the driver (economical, normal or sport/aggressive), again based on the historical driving data for the driver.

In parallel with the above functions of the driver characterisation function 510 and energy calculation function 520, the driver characterisation function 510 compares the driven speed V_{driv} with the segment speed V_{seg} for a current segment, and uses this to determine or refine a speed adjustment value, and/or the driving style of the driver. As an alternative to the above (but shown also on FIG. 5), the matrix offset Oₘₐₜ, matrix gradient Sₘₐₜ and matrix speed Vₘₐₜ (as described above) are provided to both the driver characterisation function and the energy calculation function. These are used in the same manner as the segment-based equivalents, but at lower computational cost, and result in an adjusted matrix speed V_{adj-mat} being generated and output from the driver characterisation function 510 to the energy calculation function 520, which is then used in the energy and range computations.

FIG. 6 is similar to FIG. 5. However, in this case the output of a driver characterisation function 510a to an energy calculation function 520b (which correspond to the functions 510, 520 of FIG. 5) is simply a speed correction factor Cᵥ, and a driver type D_{type} (economical, normal, or sport/aggressive). In this case the driver's driving style is simply characterised as one of a plurality of profiles (in this case 3), each with a corresponding speed correction factor. The energy calculation function 520a takes the speed correction factor supplied from the driver characterisation function 510a, and adjusts the segment speed accordingly. The energy calculation is then carried out, by the energy calculation function, using the adjusted speed values, and the range estimated based thereon.

In FIGS. 5 and 6, the eHorizon data (segment information, including segment speed, gradient and offset) is sent to both the driver characterisation function 510, 510a and the energy calculation function 520, 520a. Until the corrected speed information becomes available, the predictive energy optimisation feature will use the eHorizon speed data without adjustment. The speed profile correction will happen in parallel (in the background) based on driver's driving style. Once the driver characterisation has achieved good enough robustness of the adjustment factor(s), the speed profile will be corrected and sent to energy demand calculation function 520, 520a, every time there is an eHorizon data transmission. The corrected speed data should preferably have the same data format as the eHorizon data. The driver type (discrete values) may be sent independently of the corrected speed values.

Table 1, below, indicates an example adjustment factor for each of a plurality of (segment) speed values:

| | Speed (kph) | | | | | | | | |
|---|---|---|---|---|---|---|---|---|---|
| | 0- | 35- | 55- | 65- | 75- | 85- | 95- | 105- | |
| | 34 | 54 | 64 | 74 | 84 | 94 | 104 | 124 | 125+ |
| Adjust- | 0.85 | 0.85 | 0.93 | 0.97 | 1.05 | 1.07 | 1.10 | 1.10 | 1.05 |
| ment | | | | | | | | | |
| Factor | | | | | | | | | |

As can be seen from Table 1, the driver represented by this table typically drives at a slower speed than an average driver at lower vehicle speeds (below 75 kph) and at a higher speed than an average driver at higher vehicle speeds (75 kph+). It will be appreciated that this kind of profile (where the driver is not uniformly aggressive or economical compared with an average driver at all vehicle speeds) would be difficult to replicate with the driving style based implementation above.

The two implementations of determining an adjustment factor for each (expected) speed range based on driving data obtained corresponding to that speed range, and of determining an adjustment factor in dependence of a driving style, may be used together. Generally, driving style might be determined more quickly than the adjustment factor at certain speed ranges, since the latter may only be obtained on certain road types. For example, if a journey starts out in a residential area, the vehicle will not be driven at motorway speeds. This may enable the adjustment factors for low speed ranges to be fully determined, but will provide no data at motorway speeds. However, the low speed data may be sufficient to determine the driving style of the driver, which may be used to predict how the driver may handle the vehicle at higher speeds too. As a result, the control system may be configured to use an adjustment factor determined based on driven speeds for a speed range corresponding to the current segment if available, and to use an adjustment factor based on determined driving style otherwise. In this example, the driving style may be relied on heavily towards the beginning of a journey, but may be relied on less and less as driving data is accumulated for different speed ranges.

The above techniques work well assuming that the vehicle is always being driven by the same driver. However, in the case that a vehicle is being driven by more than one driver, the range estimates will be less accurate (due to historical driving data being based on multiple drivers although this may still be expected to be more accurate than using an estimate based on a large number of drivers as is conventionally the case). One way of addressing this issue is to identify the driver of the vehicle both in generating the historical driving data, and in selecting the adjustment factors suitable for the driver. Accordingly, the control system may be configured to receive a signal indicative of the identity of a driver of the vehicle, and to select the adjustment factor in dependence on the identified driver. The control system may also be configured to determine the adjustment factor in relation to the identified driver based on historical driving data associated with the identified driver. Any suitable way of identifying the driver may be used, such as by detecting the presence of an electronic identifier (for example a dedicated fob, or a driver's smartphone), facial recognition using a face camera, or by a user entering a code or otherwise identifying themselves to the vehicle, including by fingerprint or voice signature. In such embodiments the techniques described above are equally applicable, but the generation of the historical driving data will be carried out separately per driver, and the selection of adjustment factor will be carried out by determining the identity of the driver, determining the adjustment factor based on historical driving data for the identified driver, and then carrying out the energy consumption calculation and range estimation as per the above.

Once the range estimate is determined, the control system is configured to display the driving range estimate indicated by the outputted signal on a user interface of the vehicle.

Referring to FIG. 7, a method for estimating a driving range for an electric vehicle is shown. The method can be seen to comprise two stages, these being a learning stage in which historical driving data is accumulated which can be used to determine adjustment factors, and a range estimation stage in which the range is estimated using the determined adjustment factors. In practice the two stages may be carried out (partly or wholly) in parallel, with vehicle driven speeds being compared to expected speeds during a journey, and the adjustment factors being refined based thereon to improve the accuracy of the estimate. The first stage of the method can be seen to comprise a step S1 of monitoring a driven speed of the vehicle for a journey segment, and a step S2 of receiving an expected vehicle speed for that journey segment. Then, at a step S3, the driven speed is compared with the expected speed and a difference identified. At a step S4, the difference is stored in association with a speed range within which the expected speed falls. The process returns to the step S1 to continue monitoring, and also to a step S5 where the speed differences stored at the step S4 are used to generate adjustment factors. The adjustment factor may for example be a factor which can be multiplied by an expected speed value to result in an adjusted speed value which is substantially an average of the driven speeds previously applied by the user for that expected speed value.

The second stage of the method can be seen to comprise a step S6 of initiating a new route. This step may be manually carried out by the driver in selecting a destination in a navigation system, or may be carried out automatically by the system based on a current day and time, and previous journeys carried out by the driver. The step of initiating a new route may for example comprise determining a predicted destination for the vehicle 10. In examples, determining a predicted destination for the vehicle 10 can be performed in any suitable way using any suitable method. In examples, the predicted destination for the vehicle 10 can be determined in dependence on any suitable information/data determined in any suitable way. In examples, the information/data can be determined from any suitable source(s), for example information can be received from one or more vehicle systems 226 and/or received from one or more sources external to the vehicle and/or received from one or more user devices and/or retrieved from memory 204 and so on.

For example, the predicted destination may be determined in dependence on at least one of: time of day, day of week, week of month, month of year, a present location of the vehicle 10, number of times the vehicle 10 has stopped at a present location of the vehicle 10, number of times the vehicle 10 has travelled to a possible destination, number of times the vehicle 10 has travelled from a present location of the vehicle 10 to a possible destination, and one or more occupants of the vehicle 10. For example, it can be determined that in the past the vehicle 10 has travelled from a present location of the vehicle 10 to a particular destination at the present time of day of the present day of the week a number of times, allowing a predicted destination 12 for the vehicle 10 to be determined. In other examples, one or more destinations can be associated with a user or users of a vehicle 10. For example, a user can indicate destinations such as ‘home’ or ‘work’ and such indicated/labelled/predetermined destinations can influence the determination of a predicted destination.

Based on the determined destination, a route to be travelled by the vehicle 10 can be determined in dependence on the predicted destination. In examples, determining a route to be travelled by the vehicle 10 in dependence on the predicted destination can be performed in any suitable way using any suitable method. For example, any suitable route determining algorithm can be used to determine a route to be travelled by the vehicle 10 in dependence on the predicted destination. As used herein, determining a route is intended to include, in some examples, processing information/data such as the present location of the vehicle 10, the predicted destination and map information to determine the route and also to include receiving the route to be travelled by the vehicle 10. In examples, determining a route can be considered determining a route to allow the vehicle 10 to travel and/or traverse from the present location of the vehicle 10 to a predicted destination.

At a step S7, route information concerning the journey planned to be undertaken by the vehicle is received. At a step S8, a driving profile is determined, from the route information, for the journey, the driving profile comprising an expected vehicle speed for each of a plurality of segments of the journey. At a step S9, an adjusted vehicle speed is determined for each segment in dependence on the adjustment factor(s), for example by multiplying the vehicle speed for each segment by an adjustment factor associated with a vehicle speed range for the expected vehicle speed. Then, at a step S10, the energy consumption for the vehicle is estimated based on the adjusted vehicle speeds for each segment of the journey, for example based on Equation (1) above, and an estimated vehicle range is determined based on the estimated energy consumption for the journey. At a step S11, a signal indicative of the estimated driving range is output, and used to display the estimated driving range on a vehicle display. It will be appreciated that the step S1 to S5 may be carried out in advance of the planned journey, for example on previous journeys by the vehicle/driver. The steps S6 to S11 may be carried out, for example, when the vehicle is switched on and the journey planned. Then, the step S1 to S5 may be carried out again while the vehicle is undertaking the planned journey, leading to refined values for the adjustment factors. Then, as the adjustment factor is refined, the step S7 to S11 may be repeated (as shown in FIG. 7), to result in the range estimate being refined. In this way, the range estimate becomes more and more accurate as the vehicle is being driven, and the journey progresses.

As used herein “for” should be considered to also include “configured or arranged to”. For example, “a control system for” should be considered to also include “a control system configured or arranged to”.

For purposes of this disclosure, it is to be understood that the controller(s) described herein can each comprise a control unit or computational device having one or more electronic processors, the one or more processors collectively configured to perform the control system functionality set out in the control system claims. A vehicle and/or a system thereof may comprise a single control unit or electronic controller or alternatively different functions of the controller(s) may be embodied in, or hosted in, different control units or controllers. A set of instructions could be provided which, when executed, cause said controller(s) or control unit(s) to implement the control techniques described herein (including the described method(s)). The set of instructions may be embedded in one or more electronic processors, or alternatively, the set of instructions could be provided as software to be executed by one or more electronic processor(s). For example, a first controller may be implemented in software run on one or more electronic processors, and one or more other controllers may also be implemented in software run on one or more electronic processors, optionally the same one or more processors as the first controller. It will be appreciated, however, that other arrangements are also useful, and therefore, the present disclosure is not intended to be limited to any particular arrangement. In any event, the set of instructions described above may be embedded in a computer-readable storage medium (e.g., a non-transitory computer-readable storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

It will be appreciated that various changes and modifications can be made to the present invention without departing from the scope of the present application. The blocks illustrated in the FIG. 7 may represent steps in a method and/or sections of code in the computer program 206. The illustration of a particular order to the blocks does not necessarily imply that there is a required or preferred order for the blocks and the order and arrangement of the block may be varied. Furthermore, it may be possible for some steps to be omitted.

As used herein, the term “determining” (and grammatical variants thereof) can include, not least; calculating, computing, processing, deriving, investigating, looking up (for example, looking up in a table, a database or another data structure), ascertaining and the like. Also, “determining” can include receiving (for example, receiving information), accessing (for example, accessing data in a memory) and the like. Also “determining” can include resolving, selecting, choosing, establishing, and the like.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described. Although functions have been described with reference to certain features, those functions may be performable by other features whether described or not. Although features have been described with reference to certain embodiments, those features may also be present in other embodiments whether described or not. Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A control system for estimating a driving range for an electric vehicle, the control system comprising one or more controller, the control system configured to:
receive route information concerning a journey planned to be undertaken by the vehicle;
determine, from the route information, a driving profile for the journey, the driving profile comprising an expected vehicle speed for each of a plurality of segments of the journey;
determine an adjusted vehicle speed for each segment in dependence on an adjustment factor, the adjustment factor being based on historical driving data for the vehicle;
estimate the driving range for the vehicle based on the adjusted vehicle speeds for each segment of the journey; and
output a signal indicative of the estimated driving range.

2. The control system of claim 1, further configured to:
monitor a driven speed of the vehicle for a journey segment;
compare the driven speed of the vehicle with an expected vehicle speed for that journey segment; and
determine the adjustment factor based on a difference between the driven speed and the expected speed.

3. The control system of claim 2, further configured to compare the driven speed of the vehicle with an expected vehicle speed for each of a plurality of speed ranges, and to determine an adjustment factor for each speed range.

4. The control system of claim 2, further configured to monitor the driven speed of the vehicle, compare the driven speed of the vehicle with an expected vehicle speed, and determine the adjustment factor based on the difference, during the planned journey, and to use the newly determined adjustment factor to refine the driving range estimate.

5. The control system of claim 1, further configured to estimate the driving range by predicting an energy consumption for each of the plurality of journey segments, each journey segment representing a constant expected vehicle speed and road gradient.

6. The control system of claim 1, further configured to estimate the driving range by aggregating segments by vehicle speed and road gradient, and determining an energy consumption for each aggregated group of segments.

7. The control system of claim 1, further configured to estimate the driving range substantially immediately upon selection of the planned journey.

8. The control system of claim 1, further configured to select an adjustment factor for determining the adjusted vehicle speed in dependence on the expected vehicle speed for a segment of the journey.

9. The control system of claim 1, wherein the expected speed is based on an aggregated data set for multiple drivers.

10. The control system of claim 2, wherein if an amount of data collected and generated by the monitoring and comparing steps is less than a threshold amount for a given expected vehicle speed or speed range, the control system is further configured to estimate the driving range using the expected vehicle speed rather than an adjusted vehicle speed for that expected vehicle speed or speed range.

11. The control system of claim 1, further configured to determine a driving style based on the historical driving data, and to set the adjustment factor based on the determined driving style.

12. The control system of claim 3, further configured to use an adjustment factor determined based on driven speeds for a speed range corresponding to the current segment if available, and to use an adjustment factor based on determined driving style otherwise.

13. The control system of claim 1, further configured to receive a signal indicative of the identity of a driver of the vehicle, and to select the adjustment factor in dependence on the identified driver.

14. The control system of claim 13, further configured to determine the adjustment factor in relation to the identified driver based on historical driving data associated with the identified driver.

15. The control system of claim 1, further configured to display the driving range estimate indicated by the outputted signal on a user interface of the vehicle.

16. A vehicle comprising the control system of claim 1.

17. A method for estimating a driving range for an electric vehicle, the method comprising:
receiving route information concerning a journey planned to be undertaken by the vehicle;
determining, from the route information, a driving profile for the journey, the driving profile comprising an expected vehicle speed for each of a plurality of segments of the journey;
determining an adjusted vehicle speed for each segment in dependence on an adjustment factor, the adjustment factor being based on historical driving data for the vehicle;
estimating the driving range for the vehicle based on the adjusted vehicle speeds for each segment of the journey; and
outputting a signal indicative of the estimated driving range.

18. Computer readable instructions which, when executed by a computer, are arranged to perform the method according to claim 17.
